(19) United States
(12) Patent Application Publication
(10) Pub. No.: US 2026/0220987 A1
(43) Pub. Date: Jul. 30, 2026

(54) SYSTEMS AND METHODS FOR MONITORING A VEHICLE COMPONENT

(71) Applicant: ArvinMeritor Technology, LLC, Troy, MI (US)

(72) Inventors: Phillip G. LEICHT, South Lyon, MI (US); Daniel J. PHILPOTT, Goodrich, MI (US)

(21) Appl. No.: 19/041,838

(22) Filed: Jan. 30, 2025

(51) Int. Cl. G07C 5/08; B60R 16/023

(52) U.S. Cl. CPC G07C 5/0816; B60R 16/0232

(57) ABSTRACT

A method, computer program product, and computer system for monitoring data from at least one data source, wherein the data from the data source is representative of a parameter associated with a vehicle component of a plurality of vehicle components. It may be determined, based on the data, rate of change data of the parameter with respect to time. A current value of a statistic of the rate of change data of the parameter over a current period of time may be determined. It may be determined that the current value of the statistic exceeds a threshold for the vehicle component relative to a historical value of the statistic of the rate of change data of the parameter for at least one prior period of time. An electronic notification may be provided that the current value of the statistic exceeds the threshold.

### BACKGROUND

Some vehicles may be equipped with sensors to monitor certain vehicle parameters. Monitoring vehicle parameters, such as temperature for wheel end bearings, may be beneficial, allowing for early detection of overheating, which can prevent damage and improve vehicle safety.

### SUMMARY

In one example implementation, a method, performed by one or more computing devices, includes but is not limited to monitoring, by a computing device, data from at least one data source, wherein the data from the at least one data source is representative of a parameter associated with a vehicle component of a plurality of vehicle components. Based on the data, rate of change data of the parameter with respect to time may be determined. A current value of a statistic of the rate of change data of the parameter over a current period of time may be determined. It may be determined that the current value of the statistic exceeds a threshold for the vehicle component relative to a historical value of the statistic of the rate of change data of the parameter for at least one prior period of time. An electronic notification may be provided that the current value of the statistic exceeds the threshold for the vehicle component relative to the historical value of the statistic.

One or more of the following example features may be included. Determining that the current value of the statistic exceeds the threshold for the vehicle component relative to the historical value of the statistic may include using time window analysis. The threshold for the vehicle component may be a threshold amount of deviation in a mean value of the parameter. Determining the rate of change data of the parameter with respect to time may include summing the rate of change data from the at least one data source over the current period of time. Providing the electronic notification that the current value of the statistic exceeds the threshold for the vehicle component relative to the historical value of the statistic may include providing the electronic notification prior to the parameter exceeding a next threshold for the parameter unrelated to the rate of change of the parameter. The parameter may be one of temperature, vibration signature, and noise level. The vehicle component may be a wheel end.

In another example implementation, a computing system may include one or more processors and one or more memories configured to perform operations that includes but are not limited to monitoring data from at least one data source, wherein the data from the at least one data source is representative of a parameter associated with a vehicle component of a plurality of vehicle components. Based on the data, rate of change data of the parameter with respect to time may be determined. A current value of a statistic of the rate of change data of the parameter over a current period of time may be determined. It may be determined that the current value of the statistic exceeds a threshold for the vehicle component relative to a historical value of the statistic of the rate of change data of the parameter for at least one prior period of time. An electronic notification may be provided that the current value of the statistic exceeds the threshold for the vehicle component relative to the historical value of the statistic.

One or more of the following example features may be included. Determining that the current value of the statistic exceeds the threshold for the vehicle component relative to the historical value of the statistic may include using time window analysis. The threshold for the vehicle component may be a threshold amount of deviation in a mean value of the parameter. Determining the rate of change data of the parameter with respect to time may include summing the rate of change data from the at least one data source over the current period of time. Providing the electronic notification that the current value of the statistic exceeds the threshold for the vehicle component relative to the historical value of the statistic may include providing the electronic notification prior to the parameter exceeding a next threshold for the parameter unrelated to the rate of change of the parameter. The parameter may be one of temperature, vibration signature, and noise level. The vehicle component may be a wheel end.

In another example implementation, a computer program product may reside on a computer readable storage medium having a plurality of instructions stored thereon which, when executed across one or more processors, may cause at least a portion of the one or more processors to perform operations that includes but are not limited to monitoring data from at least one data source, wherein the data from the at least one data source is representative of a parameter associated with a vehicle component of a plurality of vehicle components. Based on the data, rate of change data of the parameter with respect to time may be determined. A current value of a statistic of the rate of change data of the parameter over a current period of time may be determined. It may be determined that the current value of the statistic exceeds a threshold for the vehicle component relative to a historical value of the statistic of the rate of change data of the parameter for at least one prior period of time. An electronic notification may be provided that the current value of the statistic exceeds the threshold for the vehicle component relative to the historical value of the statistic.

One or more of the following example features may be included. Determining that the current value of the statistic exceeds the threshold for the vehicle component relative to the historical value of the statistic may include using time window analysis. The threshold for the vehicle component may be a threshold amount of deviation in a mean value of the parameter. Determining the rate of change data of the parameter with respect to time may include summing the rate of change data from the at least one data source over the current period of time. Providing the electronic notification that the current value of the statistic exceeds the threshold for the vehicle component relative to the historical value of the statistic may include providing the electronic notification prior to the parameter exceeding a next threshold for the parameter unrelated to the rate of change of the parameter. The parameter may be one of temperature, vibration signature, and noise level. The vehicle component may be a wheel end.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF DRAWINGS

FIG. 1 is an example diagrammatic view of a monitoring process coupled to an example distributed computing network according to one or more example implementations of the disclosure;

FIG. 2 is an example diagrammatic view of a client electronic device of FIG. 1 according to one or more example implementations of the disclosure;

FIG. 3 is an example diagrammatic view of a vehicle with sensors that may be used by a monitoring process according to one or more example implementations of the disclosure;

FIG. 4 is an example flowchart of a monitoring process according to one or more example implementations of the disclosure;

FIG. 5 are example charts plotting temperature v. time and rate of change of temperature v. time according to one or more example implementations of the disclosure; and

FIG. 6 are example charts plotting the distribution of the baseline mean temperature and current mean for a single sensor, and for all sensors according to one or more example implementations of the disclosure.

Like reference symbols in the various drawings may indicate like elements.

### DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

Software may include artificial intelligence (AI) systems, which may include machine learning or other computational intelligence. For example, AI may include one or more models used for one or more problem domains (e.g., such as vehicle component monitoring and alerting). When presented with many data features, identification of a subset of features that are relevant to a problem domain may improve prediction accuracy, reduce storage space, and increase processing speed. This identification may be referred to as feature engineering. Feature engineering may be performed by users or may only be guided by users. In various implementations, a machine learning system may computationally identify relevant features, such as by performing singular value decomposition on the contributions of different features to outputs.

In some implementations, the various computing devices may include, integrate with, link to, exchange data with, be governed by, take inputs from, and/or provide outputs to one or more AI systems, which may include models, rule-based systems, expert systems, neural networks, deep learning systems, supervised learning systems, robotic process automation systems, natural language processing systems, intelligent agent systems, self-optimizing and self-organizing systems, and others. Except where context specifically indicates otherwise, references to AI, or to one or more examples of AI, should be understood to encompass one or more of these various alternative methods and systems; for example, without limitation, an AI system described for enabling any of a wide variety of functions, capabilities and solutions described herein (such as optimization, autonomous operation, prediction, control, orchestration, or the like) should be understood to be capable of implementation by operation on a model or rule set; by training on a training data set of human tag, labels, or the like; by training on a training data set of human interactions (e.g., human interactions with software interfaces or hardware systems); by training on a training data set of outcomes; by training on an AI-generated training data set (e.g., where a full training data set is generated by AI from a seed training data set); by supervised learning; by semi-supervised learning; by deep learning; or the like. For any given function or capability that is described herein, neural networks of various types may be used, including any of the types described herein, and in embodiments a hybrid set of neural networks may be selected such that within the set a neural network type that is more favorable for performing each element of a multi-function or multi-capability system or method is implemented. As one example among many, a deep learning, or black box, system may use a gated recurrent neural network for a function like language translation for an intelligent agent, where the underlying mechanisms of AI operation need not be understood as long as outcomes are favorably perceived by users, while a more transparent model or system and a simpler neural network may be used for a system for automated governance, where a greater understanding of how inputs are translated to outputs may be needed to comply with regulations or policies.

Examples of the models (e.g., AI-based models) include recurrent neural networks (RNNs) such as long short-term memory (LSTM), deep learning models such as transformers, decision trees, support-vector machines, genetic algorithms, Bayesian networks, and regression analysis. Examples of systems based on a transformer model include bidirectional encoder representations from transformers (BERT) and generative pre-trained transformers (GPT). Training a machine-learning model (or other type of AI-based learning models) may include supervised learning (for example, based on labelled input data), unsupervised learning, and reinforcement learning. In various embodiments, a machine-learning model may be pre-trained by their operator or by a third-party. Problem domains include nearly any situation where structured data can be collected, and includes natural language processing (NLP), including natural language understanding (NLU), computer vision (CV), classification, image recognition, etc. Some or all of the software may run in a virtual environment rather than directly on hardware. The virtual environment may include a hypervisor, emulator, sandbox, container engine, etc. The software may be built as a virtual machine, a container, etc. Virtualized resources may be controlled using, for example, a DOCKER container platform, a pivotal cloud foundry (PCF) platform, etc. Some or all of the software may be logically partitioned into microservices. Each microservice offers a reduced subset of functionality. In various embodiments, each microservice may be scaled independently depending on load, either by devoting more resources to the microservice or by instantiating more instances of the microservice. In various embodiments, functionality offered by one or more microservices may be combined with each other and/or with other software not adhering to a microservices model.

In some implementations, as noted above, AI-based learning models may include at least one of a transformer model, a convolutional neural network, a deep learning model trained on a set of outcomes of the value chain network entity, a supervised model, a semi-supervised model, an unsupervised model, or a reinforcement model, and the training data set for the AI-based learning models may include one or a set of objects or events that are labeled to classify the set of objects or events according to a classification taxonomy. Other examples of AI-based learning models (e.g., machine learning models) may include neural networks in general (e.g., deep neural networks, convolution neural networks, and many others), regression-based models, decision trees, hidden forests, Hidden Markov models, Bayesian models, and the like. In some implementations, the present disclosure may include combinations where an expert system uses one neural network for classifying an item and a different (or the same) neural network for predicting a state of the item.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium or storage device may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, solid state drives (SSDs), a digital versatile disk (DVD), a Blu-ray disc, and an Ultra HD Blu-ray disc, a static random access memory (SRAM), dynamic RAM (DRAM), synchronous DRAM (SDRAM), synchronous graphics RAM (SGRAM), and video RAM (VRAM), analog magnetic tape, digital magnetic tape, rotating hard disk drive (HDDs), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device. Examples of storage implemented by the storage hardware include a distributed ledger, such as a permissioned or permissionless blockchain. Entities recording transactions, such as in a blockchain, may reach consensus using an algorithm such as proof-of-stake, proof-of-work, and proof-of-storage.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, state information that personalizes electronic circuitry and/or other structural components that are native to hardware (e.g., host processor, central processing unit/CPU, microcontroller, etc.) or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a network, such as a cellular network, local area network (LAN), a wide area network (WAN), a body area network BAN), a personal area network (PAN), a metropolitan area network (MAN), etc., or the connection may be made to an external computer (for example, through the internet using an Internet Service Provider). The networks may include one or more of point-to-point and mesh technologies. Data transmitted or received by the networking components may traverse the same or different networks. Networks may be connected to each other over a WAN or point-to-point leased lines using technologies such as Multiprotocol Label Switching (MPLS) and virtual private networks (VPNs), etc. In some implementations, electronic circuitry including, for example, programmable logic circuitry, an application specific integrated circuit (ASIC), gate arrays such as field-programmable gate arrays (FPGAs) or other hardware accelerators, micro-controller units (MCUs), or programmable logic arrays (PLAs), integrated circuits (ICs), digital circuit elements, analog circuit elements, combinational logic circuits, digital signal processors (DSPs), complex programmable logic devices (CPLDs), memory chips, network chips, systems on chip (SoCs), SSD/NAND controller ASICs, and the like, etc. may execute the computer readable program instructions/code by utilizing state information of the computer readable program instructions to personalize the electronic circuitry, in order to perform aspects of the present disclosure. Configurable or fixed-functionality logic may be implemented with complementary metal oxide semiconductor (CMOS) logic circuits, transistor-transistor logic (TTL) logic circuits, or other circuits. Multiple components of the hardware may be integrated, such as on a single die, in a single package, or on a single printed circuit board or logic board. For example, multiple components of the hardware may be implemented as a system-on-chip. A component, or a set of integrated components, may be referred to as a chip, chipset, chiplet, or chip stack. Examples of a system-on-chip include a radio frequency (RF) system-on-chip, an AI system-on-chip, a video processing system-on-chip, an organ-on-chip, a quantum algorithm system-on-chip, etc.

Examples of processing hardware may include, e.g., a central processing unit (CPU), a graphics processing unit (GPU), an accelerator (e.g., an AI accelerator), an approximate computing processor, a quantum computing processor, a parallel computing processor, a neural network processor, a signal processor, a digital processor, an analog processor, a data processor, an embedded processor, a microprocessor, and a co-processor. The co-processor may provide additional processing functions and/or optimizations, such as for speed or power consumption. Examples of a co-processor include a math co-processor, a graphics co-processor, a communication co-processor, a video co-processor, and an AI co-processor.

In some implementations, the AI accelerator may include suitable logic, circuitry, and/or interfaces to accelerate artificial intelligence applications, such as, e.g., artificial neural networks, machine vision and machine learning applications, including through parallel processing techniques. In one or more examples, the AI accelerator may include hardware logic or devices such as, e.g., a GPU or an FPGA. The AI accelerator may be used with any of the devices, components, features or methods described herein.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved. In addition, in some of the drawings, signal conductor lines may be represented with lines. Some may be different, to indicate more constituent signal paths, have a number label, to indicate a number of constituent signal paths, and/or have arrows at one or more ends, to indicate primary information flow direction(s). This, however, should not be construed in a limiting manner. Rather, such added detail may be used in connection with one or more implementations to facilitate ease of understanding. Any represented lines, whether or not having additional information, may actually comprise one or more signals/information that may travel in multiple directions and may be implemented with any suitable type of signal scheme, e.g., digital or analog lines implemented with differential pairs, optical fiber lines, and/or single-ended lines, etc.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

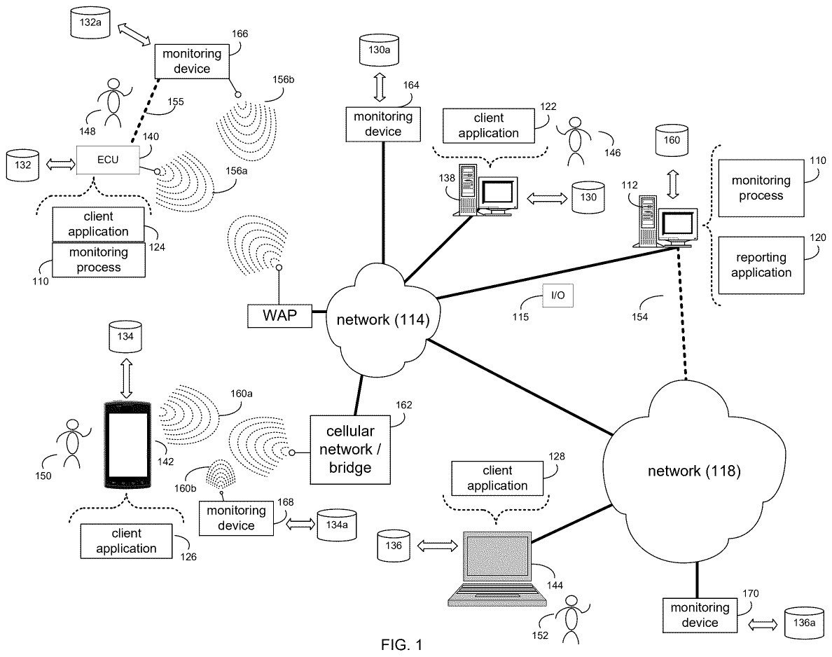

Referring now to the example implementation of FIG. 1, there is shown monitoring process 110 that may reside on and may be executed by a computer (e.g., computer 112), which may be connected to a network (e.g., network 114) (e.g., the internet or a local area network). Examples of computer 112 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). A SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a monitoring process, such as monitoring process 110 of FIG. 1, may monitor, by a computing device, data from at least one data source, wherein the data from the at least one data source is representative of a parameter associated with a vehicle component of a plurality of vehicle components. It may be determined, based on the data, rate of change data of the parameter with respect to time. A current value of a statistic of the rate of change data of the parameter over a current period of time may be determined. It may be determined that the current value of the statistic exceeds a threshold for the vehicle component relative to a historical value of the statistic of the rate of change data of the parameter for at least one prior period of time. An electronic notification may be provided that the current value of the statistic exceeds the threshold for the vehicle component relative to the historical value of the statistic.

In some implementations, the instruction sets and subroutines of monitoring process 110, which may be stored on storage device, such as storage device 160, coupled to computer 112, may be executed by one or more processors and one or more memory architectures included within computer 112. In some implementations, storage device 160 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 160 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 114 may be connected to one or more secondary networks (e.g., network 118), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 112 may include a data store, such as a database (e.g., relational database, object-oriented database, triplestore database, etc.), a data store, a data lake, a column store, and/or a data warehouse, and may be located within any suitable memory location, such as storage device 160 coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, monitoring process 110 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 160 may refer to multiple devices, which may also be distributed throughout the network.

In some implementations, computer 112 may execute a reporting application (e.g., reporting application 120), examples of which may include, but are not limited to, e.g., a dashboard display system application designed to monitor and display vehicle sensor information to a driver, such as a built-in vehicle dashboard or an aftermarket solution that can integrate with various sensors and provide real-time data, a digital dashboard application, a head-up display (HUD) application, a telematics application (e.g., fleet management dashboard application), a mobile application-based dashboard application, or other application that allows for monitoring, displaying, and/or providing alerts for sensor values like speed, RPM, tire pressure, and temperatures, a data logging application to store historical data for analysis, a remote monitoring application to receive/send data from/to a cloud-based dashboard for off-site access, an Instant Messaging (IM)/“chat” application, a chatbot application, an interactive voice response (IVR) application, a short messaging service (SMS)/multimedia messaging n service (MMS) application. In some implementations, monitoring process 110 and/or reporting application 120 may be accessed via one or more of client applications 122, 124, 126, 128. In some implementations, monitoring process 110 may be a standalone application, or may be an applet/application/script/extension that may interact with and/or be executed within reporting application 120, a component of reporting application 120, and/or one or more of client applications 122, 124, 126, 128. In some implementations, reporting application 120 may be a standalone application, or may be an applet/application/script/extension that may interact with and/or be executed within monitoring process 110, a component of monitoring process 110, and/or one or more of client applications 122, 124, 126, 128. In some implementations, one or more of client applications 122, 124, 126, 128 may be a standalone application, or may be an applet/application/script/extension that may interact with and/or be executed within and/or be a component of monitoring process 110 and/or reporting application 120. Examples of client applications 122, 124, 126, 128 may include, but are not limited to, e.g., a dashboard display system application designed to monitor and display vehicle sensor information to a driver, such as a built-in vehicle dashboard or an aftermarket solution that can integrate with various sensors and provide real-time data, a digital dashboard application, a head-up display (HUD) application, a telematics application (e.g., fleet management dashboard application), a mobile application-based dashboard application, or other application that allows for monitoring, displaying, and/or providing alerts for sensor values like speed, RPM, tire pressure, and temperatures, a data logging application to store historical data for analysis, a remote monitoring application to receive/send data from/to a cloud-based dashboard for off-site access, an Instant Messaging (IM)/“chat” application, a chatbot application, an interactive voice response (IVR) application, a short messaging service (SMS)/multimedia messaging service (MMS) application, a virtual assistant application, a data monitoring application, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, 130a, 132a, 134a, 136a, coupled to client electronic devices 138, 140, 142, 144 and/or monitoring devices 164, 166, 168, 170, may be executed by one or more processors and one or more memory architectures incorporated into client electronic devices 138, 140, 142, 144 and/or monitoring devices 164, 166, 168, 170.

In some implementations, one or more of storage devices 130, 132, 134, 136, 130a, 132a, 134a, 136a, may include but are not limited to: hard disk drives; flash drives, tape drives; optical drives; RAID arrays; random access memories (RAM); and read-only memories (ROM). Examples of client electronic devices 138, 140, 142, 144 (and/or computer 112) may include, but are not limited to, a personal computer (e.g., client electronic device 138), a vehicle's electronic control unit (ECU) (e.g., client electronic device 140, which may encompass some or all of the electronic controls (e.g., microprocessor-controlled units) in a vehicle, managing a wide array of functions, from vehicle component monitoring systems, engine operation and fuel efficiency, to handling braking systems, airbag deployment, infotainment systems, transmission systems, climate control, fuel cell operation, radiator systems, etc.), a smart/data-enabled, cellular phone (e.g., client electronic device 142), a notebook computer (e.g., client electronic device 144), a tablet, a server, a television, a smart television, a laptop, a smart speaker, an Internet of Things (IOT) device, a media (e.g., audio/video, photo, etc.) capturing and/or output device, an audio input and/or recording device (e.g., a handheld microphone, a lapel microphone, an embedded microphone/speaker (such as those embedded within eyeglasses, smart phones, tablet computers, smart televisions, wearables such as watches, headsets or glasses with a head-up display (HUD) capable of executing a virtual reality (VR) application, an extended reality (XR) application also known as mixed reality (MR), and/or an augmented reality (AR) application, vehicle health monitoring device, etc.), an infotainment device (e.g., such as those found in vehicles combining information and/or entertainment with optional screens and/or audio for such things as navigation, multimedia, connectivity, voice control, smartphone integration, touchscreen interface, internet and apps, rear-seat entertainment, etc.), a dedicated network device, and combinations thereof. Additionally/alternatively, one or more of client electronic devices 138, 140, 142, 144 may include and/or communicate with a monitoring device (e.g., monitoring device 164, 166, 168, 170), capable of receiving sensor data for vehicle components, as will be discussed in greater detail below. Client electronic devices 138, 140, 142, 144 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 122, 124, 126, 128 may be configured to effectuate some or all of the functionality of monitoring process 110 (and vice versa). Accordingly, in some implementations, monitoring process 110 may be a purely server-side application, a purely client-side application, or a hybrid server-side/client-side application that is cooperatively executed by one or more of client applications 122, 124, 126, 128 and/or monitoring process 110.

In some implementations, one or more of client applications 122, 124, 126, 128 may be configured to effectuate some or all of the functionality of reporting application 120 (and vice versa). Accordingly, in some implementations, reporting application 120 may be a purely server-side application, a purely client-side application, or a hybrid server-side/client-side application that is cooperatively executed by one or more of client applications 122, 124, 126, 128 and/or reporting application 120. As one or more of client applications 122, 124, 126, 128, monitoring process 110, and reporting application 120, taken singly or in any combination, may effectuate some or all of the same functionality, any description of effectuating such functionality via one or more of client applications 122, 124, 126, 128, monitoring process 110, reporting application 120, or combination thereof, and any described interaction(s) between one or more of client applications 122, 124, 126, 128, monitoring process 110, reporting application 120, or combination thereof to effectuate such functionality, should be taken as an example only and not to limit the scope of the disclosure.

In some implementations, one or more of users 146, 148, 150, 152 and/or one or more of monitoring devices 164, 166, 168, 170 may access computer 112 and monitoring process 110 (e.g., using one or more of client electronic devices 138, 140, 142, 144) directly through network 114 or through network 118. Further, computer 112 may be connected to network 114 through network 118, as illustrated with phantom link line 154. Monitoring process 110 may include one or more user interfaces, such as browsers and textual or graphical user interfaces, through which users 146, 148, 150, 152 may access monitoring process 110 and/or monitoring devices 164, 166, 168, 170.

In some implementations, one or more of the various client electronic devices and/or one or more of monitoring devices 164, 166, 168, 170 may be directly or indirectly coupled to network 114 (or network 118). For example, client electronic device 138 (e.g., personal computer) and monitoring device 164 are shown directly coupled to network 114 via a hardwired network connection. Further, notebook computer (e.g., client electronic device 144) and monitoring device 170 are shown directly coupled to network 118 via a hardwired network connection. ECU (e.g., client electronic device 140) and monitoring device 166 are shown wirelessly coupled to network 114 via wireless communication channels 156a and 156b respectively established between ECU (e.g., client electronic device 140) and wireless access point (i.e., WAP 158) and between monitoring device 166 and WAP 158, which is shown directly coupled to network 114. WAP 158 may be, for example, an IEEE 802.11a, 802.11b, 802.11g, Wi-Fi®, RFID, and/or Bluetooth™ (including Bluetooth™ Low Energy) device that is capable of establishing wireless communication channel 156a between ECU (e.g., client electronic device 140) and WAP 158 and wireless communication channel 156b between monitoring device 166 and WAP 158 (e.g., Zigbee, Z-Wave, etc.). Additionally/alternatively, a monitoring device (e.g., monitoring device 166) may be directly (and/or wirelessly) coupled to an ECU (e.g., client electronic device 140) as illustrated with phantom link line 155. Thus, information may be communicated from a monitoring device (e.g., monitoring device 166) to an ECU (e.g., client electronic device 140), where the information may be communicated, e.g., to computer 112 via, e.g., a network (e.g., network 114). Smart phone (e.g., client electronic device 142) and monitoring device 168 are shown wirelessly coupled to network 114 via wireless communication channels 160a and 160b respectively established between smart phone (e.g., client electronic device 142) and cellular network/bridge 162 and monitoring device 168 and cellular network/bridge 162, which is shown by example directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices (e.g., monitoring devices 164, 166, 168, 170) to be interconnected using a short-range wireless connection. Other forms of interconnection (e.g., Near Field Communication (NFC)) may also be used. In some implementations, computer 112 may be directed or controlled by an operator. Computer 112 may be hosted by one or more of assets owned by the operator, assets leased by the operator, and third-party assets. The assets may be referred to as a private, community, or hybrid cloud computing network or cloud computing environment. For example, computer 112 may be partially or fully hosted by a third-party offering software as a service (SaaS), platform as a service (PaaS), and/or infrastructure as a service (IaaS).

In some implementations, various I/O requests (e.g., I/O request 115) may be sent from, e.g., client applications 122, 124, 126, 128 to, e.g., computer 112 (and vice versa). Examples of I/O request 115 may include but are not limited to, data write requests (e.g., a request that content be written to computer 112) and data read requests (e.g., a request that content be read from computer 112). Client electronic devices 138, 140, 142, 144 and/or computer 112 may also communicate audibly using an audio codec, which may receive spoken information from a user and convert it to usable digital information. An audio codec may likewise generate audible sound for a user, such as through a speaker, e.g., in a handset of a client electronic device. Such sound may include sound from voice telephone calls, may include recorded sound (e.g., voice messages, music files, etc.) and may also include sound generated by applications operating on the client electronic devices.

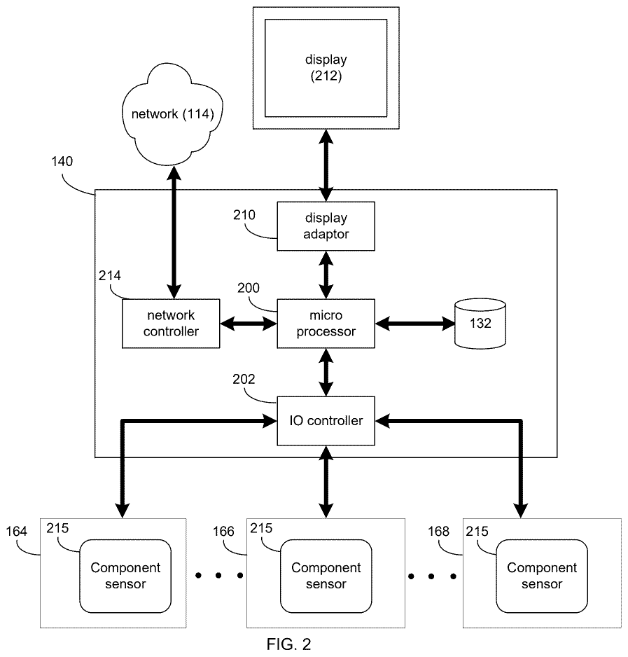

Referring also to the example implementation of FIG. 2, there is shown a diagrammatic view of client electronic device 140. While client electronic device 140 is shown in this figure, this is for example purposes only and is not intended to be a limitation of this disclosure, as other configurations are possible. Additionally, any computing device capable of executing, in whole or in part, monitoring process 110 may be substituted for client electronic device 140 (in whole or in part) within FIG. 2, examples of which may include but are not limited to computer 112 and/or one or more of client electronic devices 138, 142, 144 and/or one or more of monitoring devices 164, 166, 168, 170.

In some implementations, client electronic device 140 may include a processor (e.g., microprocessor 200) configured to, e.g., process data and execute the above-noted code/instruction sets and subroutines. Microprocessor 200 may be coupled via a storage adaptor to the above-noted storage device(s) (e.g., storage device 132). An I/O controller (e.g., I/O controller 202) may be configured to couple microprocessor 200 with various devices (e.g., via wired or wireless connection), such as a keyboard, pointing/selecting device (e.g., touchpad, touchscreen, mouse, etc.), a monitoring device (e.g., component sensor 215, which may be a part of or separate from the monitoring devices discussed above), USB ports, or other ports. A display adaptor (e.g., display adaptor 210) may be configured to couple display 212 (e.g., LED panel, dashboard, touchscreen monitor(s), plasma, CRT, or LCD monitor(s), etc.) with microprocessor 200, while network controller/adaptor 214 (e.g., an Ethernet adaptor, a wireless adaptor, etc.) may be configured to couple microprocessor 200 to network 114 (e.g., the Internet or a local area network).

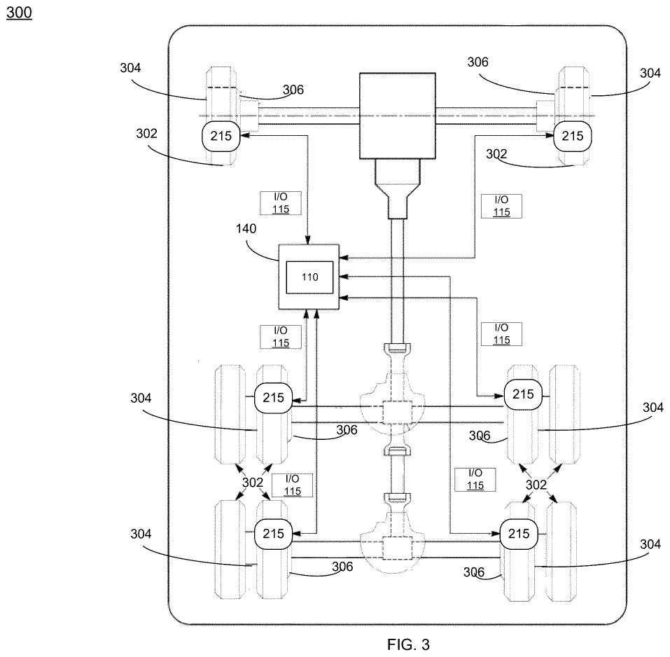

Referring also to the example implementation of FIG. 3, there is shown a diagrammatic view of an example vehicle (e.g., vehicle 300). In the example, vehicle 300 may be a vehicle like a truck, farm equipment, military transport or weaponry vehicle, or cargo loading equipment for land, air, or marine vessels, etc. In some implementations, vehicle 300 may include a trailer for transporting cargo. As will be appreciated after reading the present disclosure, vehicle 300 may include a brake assembly, which may help facilitate braking of a wheel (e.g., wheel 304) upon which at least one tire (e.g., tire 302) may be disposed. While vehicle 300 is shown with six wheel ends, vehicle 300 may include more or fewer wheel ends without departing from the scope of the present disclosure. In some implementation, as will be discussed in greater detail below, vehicle 300 may include client electronic device 140, which may receive data from one or more data sources. In the example, the data sources may include one or more sensors (e.g., component sensor 215), which may be used to measure various parameters for various components. For instance, component sensor 215 may be located proximate the brake assembly (e.g., proximate a wheel end, such as wheel end 306). As is known to those skilled in the art, the wheel end of a vehicle refers to the components located at the outermost end of the axle, near each wheel. These components are used for connecting the wheels to the vehicle and ensuring proper rotation, braking, and load support. Example components may include the hub assembly, brake components, wheel bearings, axle or spindle, wheel studs and lug nuts, etc.

In some implementations, component sensor 215 may be a temperature sensor for monitoring the temperature of a wheel end (e.g., wheel end bearings or any other components of or proximate enough to a wheel end to monitor temperature). An example of such a temperature sensor is the Tire Pressure Monitoring System (TPMS), designed to provide real-time monitoring of tire pressure and temperature, as well as the Digital ThermALERT™, both provided by Pressure Systems International (PSI) of San Antonio, TX. In some implementations, component sensor 215 may be placed in various locations, including those locations that ensure accurate and direct measurement without interfering with the wheel's operation. Example placements may include mounting component sensor 215 on the exterior of the hub or bearing housing, integrating it directly into the bearing assembly, or positioning it near the wheel-end seal to capture heat from the bearing. In some examples, component sensor 215 may be attached (e.g., inside/outside) to the axle or spindle (using, for example, the support member disclosed in U.S. patent application Ser. No. 18/907,943 entitled “Support Member For Routing A Fluid or Electrical Line In A Structural Member” owned by the same assignee of the instant application), placed inside the hub cap, or located near the brake components, as brakes and bearings are thermally connected. However, it will be appreciated by those skilled in the art after reading the present disclosure that the chosen location placement may vary to balance effective heat conduction detection, durability against vibrations, protection from environmental factors like dirt and water, and ease of access for maintenance. As such, the specific locations of component sensor 215 discussed throughout should be taken as example only and not to otherwise limit the scope of the present disclosure.

Some vehicles may be equipped with sensors to monitor certain vehicle parameters. Monitoring vehicle parameters, such as temperature for wheel end bearings, may be beneficial, allowing for early detection of overheating, which can prevent damage and improve vehicle safety. However, relying on a simple absolute temperature threshold to trigger alerts has significant limitations. While such thresholds (e.g., greater than 250° F.) can identify dangerously high temperatures, they often fail to provide the nuanced insights needed for proactive maintenance. For instance, an absolute threshold cannot account for gradual trends or context, such as a slow but steady rise in temperature that signals impending bearing failure. This lack of context means issues might only be addressed after reaching critical levels, increasing the risk of catastrophic failure.

Additionally, using absolute thresholds can produce false positives in situations where temporary factors, such as braking downhill, cause a short-term temperature spike. In such cases, the rise in temperature is not indicative of a bearing issue but rather a normal reaction to increased friction from braking. These false alerts can lead to unnecessary inspections, operational delays, or even parts replacement, adding costs without addressing any real problem. Therefore, as will be discussed in greater detail below, the present disclosure may improve existing component monitoring systems by combining monitoring and trend analysis, allowing the detection of abnormal temperature patterns over time by their rate of change, and investigate potential issues proactively, reducing both false positives and the likelihood of sudden failures.

### The Monitoring Process:

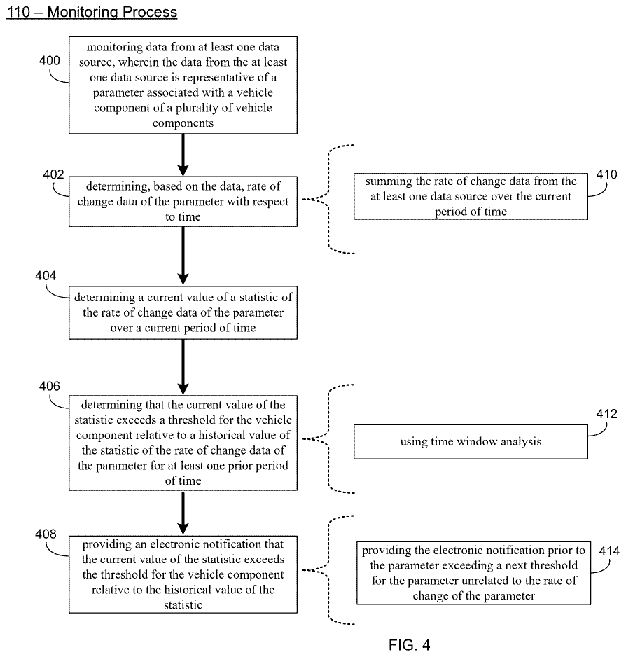

As discussed above and referring also at least to the example implementations of FIGS. 4-6, monitoring process 110 may monitor 400, by a computing device, data from at least one data source, wherein the data from the at least one data source is representative of a parameter associated with a vehicle component of a plurality of vehicle components. Monitoring process 110 may determine 402, based on the data, rate of change data of the parameter with respect to time. Monitoring process 110 may determine 404 a current value of a statistic of the rate of change data of the parameter over a current period of time. Monitoring process 110 may determine 406 that the current value of the statistic exceeds a threshold for the vehicle component relative to a historical value of the statistic of the rate of change data of the parameter for at least one prior period of time. Monitoring process 110 may provide 408 an electronic notification that the current value of the statistic exceeds the threshold for the vehicle component relative to the historical value of the statistic.

In some implementations, monitoring process 110 may monitor 400, by a computing device, data from at least one data source, wherein the data from the at least one data source is representative of a parameter associated with a vehicle component of a plurality of vehicle components. For instance, monitoring process 110 may monitor 400 data from at least one data source (e.g., component sensor 215), where the data of component sensor 215 is representative of a parameter (e.g., temperature data) associated with a vehicle component (e.g., a wheel end) of a plurality of components. As an example, and referring again to FIG. 3, component sensor 215 may be a temperature sensor for monitoring the temperature of wheel end bearings. An example of such a temperature sensor are those discussed above. In some implementations, component sensor 215 may be placed in various locations, including those locations that ensure accurate and direct measurement without interfering with the wheel's operation. Example placements may include mounting component sensor 215 on the exterior of the hub or bearing housing, integrating it directly into the bearing assembly, or positioning it near the wheel-end seal to capture heat from the bearing. In some examples, component sensor 215 may be attached (e.g., inside/outside) to the axle or spindle, placed inside the hub cap, or located near the brake components, as brakes and bearings are thermally connected. In the example, and as noted above, the temperature data (e.g., I/O request 115) received by component sensor 215 may be transmitted to client electronic device 140 for the analysis discussed further below. However, it will be appreciated after reading the present disclosure that the temperature data may also be transmitted to a remote computing device (e.g., computer 112), which may perform some or all of the analysis discussed further below, thereafter providing the results of the analysis back to client electronic device 140 (or other computing device). As such, the discussion of client electronic device 140 performing all the analysis discussed further below should be taken as example only, and not to otherwise limit the scope of the present disclosure.

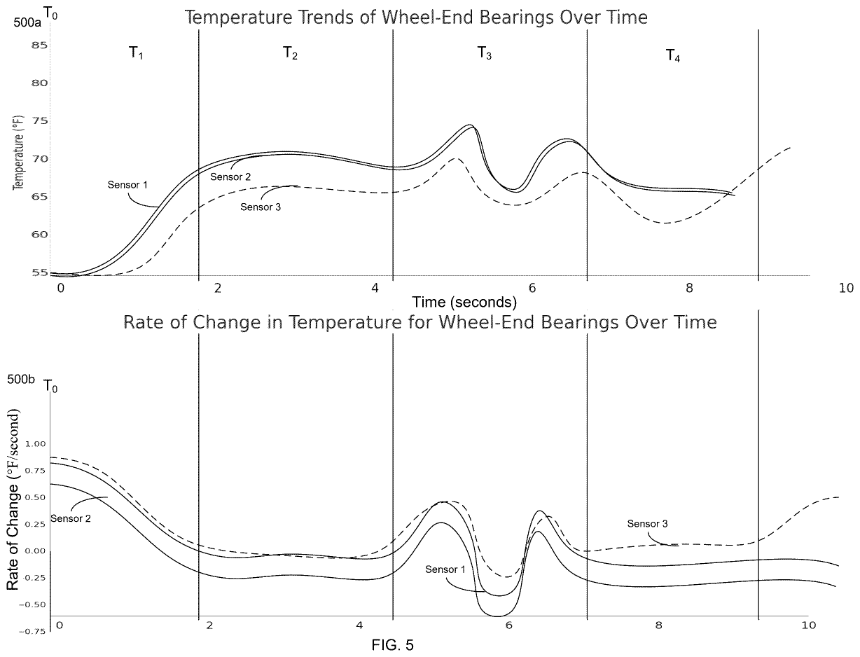

Referring at least to the example implementation of FIG. 5, an example chart 500a plotting temperature trends from three wheel end sensors over time is shown. The x-axis represents time in hours, while the y-axis represents temperature in degrees Fahrenheit. It is noted that the curves shown in FIG. 5 are for illustrative purposes only, and may otherwise not be drawn to scale or with high degrees of accuracy. The chart is divided into four distinct example time frames: T1, T2, T3, and T4, marked by vertical lines. During T1, T2, and T3, all three sensors follow a relatively similar trend, with temperature fluctuations likely caused by normal operating conditions. However, at the end of T4, Sensor 3 begins to diverge significantly from the other two sensors, displaying a noticeable increase in temperature. This divergence indicates a potential issue with the wheel end bearing associated with Sensor 3, such as overheating, which may require further investigation to prevent a possible failure. It will be appreciated that more or fewer sensors may be used without departing from the scope of the present disclosure.

In some implementations, monitoring process 110 may determine 402, based on the data, rate of change data of the parameter with respect to time. For example, to determine 402 the rate of change of the temperature data with respect to time from sensor data, monitoring process 110 may determine the temperature derivative over time. For instance, monitoring process 110 may extract the temperature data points for each sensor as a function of time. For discrete data, the rate of change may be determined using the difference in temperature (ΔTemperature) and the corresponding difference in time (ΔTime) between successive points.

Rate of Change=ΔTemperature/ΔTime.

If the data contains significant noise or fluctuations, monitoring process 110 may apply a smoothing technique such as a moving average prior to calculation. Once the rate of change is determined, monitoring process 110 may plot it on a new chart (e.g., shown at chart 500b), with time on the x-axis and the rate of change in temperature (e.g., ° F./hour, ° F./minutes, ° F./second, ° F./ms, or other time frames, etc.) on the y-axis. In some implementations, for greater precision, numerical differentiation methods like central difference or spline interpolation may be used. For example, the central difference formula calculates the rate of change at a specific point using the surrounding data points, where t is time and T is temperature:

$$( {T}_{i + 1} - {T}_{i - 1} ) / ( {t}_{i + 1} - {t}_{i - 1} ) .$$

Alternatively, spline interpolation can be applied for a smoother representation of the data, making the rate of change calculations more accurate, particularly for irregular datasets. These advanced techniques help to better capture subtle trends and patterns. As shown in chart 500b, the rate of change in temperature for three wheel end bearing sensors over time is shown. The x-axis represents time in seconds, while the y-axis represents the rate of change in temperature in degrees Fahrenheit per second (° F./second). Like chart 500a, chart 500b is divided into four distinct time frames—T1, T2, T3, and T4-marked by vertical lines (although it will be appreciated that more or fewer timeframes may be used). Throughout T1, T2, and most of T3, all three sensors exhibit similar trends, with their rates of change occasionally fluctuating but generally aligning.

It will be appreciated after reading the present disclosure that while a sampling rate of 1-10 seconds may be beneficial for certain components, longer sampling rates, such as hourly, may enable bulk analysis that could pick up gross errors, and calculations over multiple time horizons may have different statistics of interest. As such, the use of any particular sampling rate should be taken as example only.

In some implementations, determining the rate of change data of the parameter with respect to time may include summing 410 the rate of change data from the at least one data source over the current period of time. For example, during T3, the rates of change for all sensors sum to approximately zero, indicating a steady state where no overall temperature change occurs (i.e., normal/stable operation with fluctuations between-0.5° F./second to +0.5° F./second). This summing may aid in filtering out noise (i.e., normal rate changes in temperature), which may increase the accuracy of the calculations, as well as avoid unnecessary processor usage to perform unnecessary tasks associated with the noisy data. At the end of T4, however, Sensor 3 begins to diverge from the other two sensors, showing a significant positive rate of change, which could signal an emerging issue with that specific wheel-end bearing (e.g., a notable rise to +1° F./second for Sensor 3). It will be appreciated that the visual plots are shown for ease of explanation and are not required by monitoring process 110 to perform any of the analysis discussed throughout.

In some implementations, monitoring process 110 may determine 404 a current value of a statistic of the rate of change data of the parameter over a current period of time. For example, to determine the current value of a statistic, such as the mean value of the rate of change data of the temperature over a specific period of time, monitoring process 110 may define the current time period. This may be a default setting, or may be a setting provided by a user via a user interface of, e.g., client application 124. In some implementations, this involves selecting a range of interest, such as the last 1 second or the last 10 data points, depending on the needs of the analysis. For instance, if the rate of change data is sampled every minute, the current period could encompass the last 60 minutes, corresponding to 60 data points. Monitoring process 110 may then extract the rate of change data points that fall within the chosen time range. For example, if the time range spans from T₃ to T₄, monitoring process 110 may isolate the data points corresponding to that interval. Once the data is extracted, monitoring process 110 may calculate the statistic, such as the mean, using the example formula:

$$Mean Rate of Change = \frac{1}{N} {\sum }_{i = 1}^{N} {Δ}_{i}$$

where N is the number of data points in the current period and Δᵢ represents the rate of change values. Optionally, for scenarios where recent data points should be prioritized, alternative methods, such as a weighted mean or an exponentially weighted moving average (EWMA), may be used. The weighted mean may be calculated using the formula:

$$Weighted Mean = \frac{{\sum }_{i = 1}^{N} {w}_{i} \cdot {Δ}_{i}}{{\sum }_{i = 1}^{N} {w}_{i}}$$

where wᵢ represents the weights assigned to each data point, with larger weights often given to more recent data. In some implementations, for real-time monitoring, monitoring process 110 may continuously recalculate the statistic as new data points arrive by employing a rolling or sliding window approach. For instance, a sliding window can be used to define the current time period (e.g., the last 60 seconds), recalculating the mean as new data points arrive within the current 60 seconds. In some implementations, as will be discussed below, the mean can be visualized on a dashboard or chart for easy interpretation by a user, enabling dynamic insights into trends and potential anomalies in real-time. This process ensures the statistic remains up-to-date and actionable, providing valuable diagnostic and operational information.

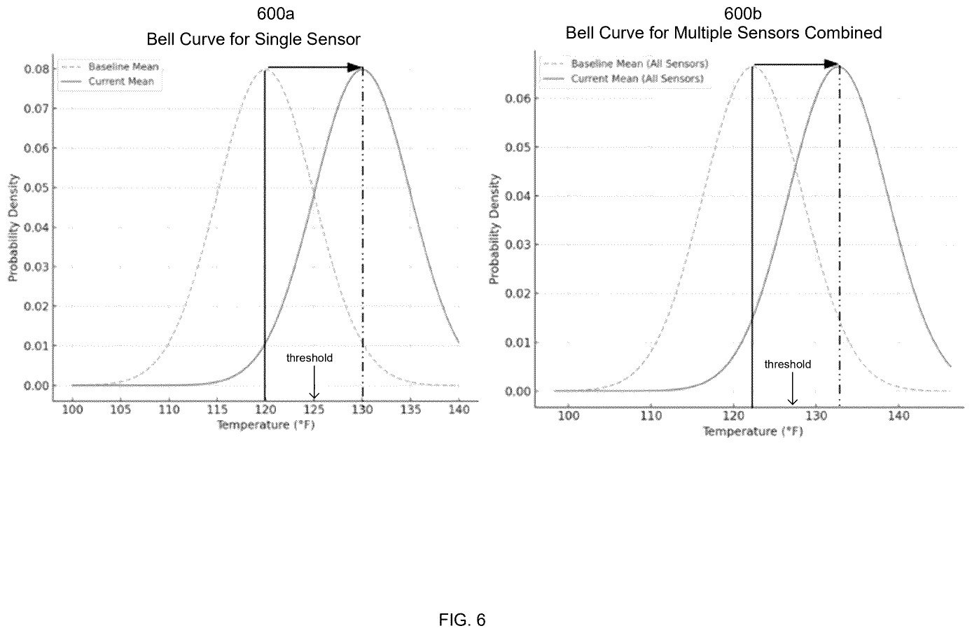

In some implementations, monitoring process 110 may determine 406 that the current value of the statistic exceeds a threshold for the vehicle component relative to a historical value of the statistic of the rate of change data of the parameter for at least one prior period of time. For instance, in some implementations, the threshold for the vehicle component may be a threshold amount of deviation in a mean value of the parameter. For example, and referring at least to the example implementation of FIG. 6, an example chart 600a plotting the distribution of the baseline mean temperature and current mean for a single sensor is shown, as is a chart 600b plotting the distribution of the baseline mean temperature and current mean for all sensors. In the example, to determine whether the current value of the statistic, such as the mean, exceeds a threshold relative to a historical value for the rate of change data, where the threshold is defined as the amount of deviation in the mean value, chart 600a shows that the bell curve represents the distribution of rate of change values for a single sensor (e.g., component sensor 215). The dashed line represents the baseline mean, calculated from historical data, at approximately 120° F., while the solid line represents the current mean, calculated from the most recent (current) data period, at approximately 130° F. The deviation between the current mean and the baseline mean is 130° F.-120° F.=10° F. If the defined threshold for deviation is, for example, 5° F., this indicates that the current mean exceeds the threshold. The significant rightward shift of the solid curve relative to the dashed curve suggests that the sensor's rate of change mean has deviated substantially from historical norms, potentially indicating an abnormal condition in the monitored component. Conversely, if the shift in the current mean were less than or equals 4.9° F., this may indicate that the current mean does not exceed the threshold, and may be considered a normal temperature variation. It will be appreciated that the threshold may be a default threshold, or a threshold set by the user (e.g., via a user interface of client application 124).

In some implementations, multiple sensors may be used, as shown in chart 600b, where the bell curves represents the aggregated distribution of rate of change values across multiple sensors (e.g., all sensors in the system, all sensors for a particular wheel end or set of two or more wheel ends, multiple sensors for various different components, etc.). The dashed line represents the baseline mean for multiple sensors combined, approximately 122° F., while the solid line represents the current mean, calculated from recent (current) data, at approximately 132° F. The deviation between the current combined mean and the baseline combined mean is 132° F.-122° F.=10° F. If the threshold is set at the example 5° F., the deviation exceeds this threshold, indicating a system-wide issue impacting multiple components. The clear rightward shift of the solid curve relative to the dashed curve reflects a significant deviation in the aggregated behavior of the sensors from historical values. Conversely, if the shift in the current mean were less than or equals 4.9° F., this may indicate that the current mean does not exceed the threshold, and may be considered a normal temperature variation. It will be appreciated that the threshold may be a default threshold, or a threshold set by the user (e.g., via a user interface of client application 124). By defining a deviation threshold, such as 5° F., and comparing the current mean against the baseline mean, monitoring process 110 may identify whether the current behavior of the rate of change exceeds acceptable thresholds. The single sensor analysis pinpoints specific abnormalities in individual components, while the combined sensors analysis provides a broader system-wide perspective.

In some implementations, determining that the current value of the statistic exceeds the threshold for the vehicle component relative to the historical value of the statistic may include using 412 time window analysis. For instance, monitoring process 110 may use time window analysis by segmenting the sensor data into defined time intervals, or windows, to analyze and compare statistical values across these periods. To determine whether the current value of a statistic, such as the mean rate of change, exceeds a threshold relative to historical data, monitoring process 110 may identify the time windows for analysis. For instance, the baseline windows may represent historical data from earlier periods, such as T1, T2, and T3, while the current window represents the most recent (current) time period, such as T4. For each window, the statistic of interest, such as the mean rate of change, may be calculated similarly as noted above, where Nis the number of data points in the window and Δᵢ represents the rate of change values.

In the case of a single sensor, as shown in the left-hand chart 600a, the mean rate of change for the baseline windows (T1 to T3) is approximately 120° F., while the mean for the current window (T4) is approximately 130° F. The deviation between these means is calculated as 130° F.-120° F.=10° F. This deviation is then compared to a predefined threshold, such as 5° F. Since the deviation exceeds the threshold, it indicates a significant change in the behavior of the monitored parameter, suggesting a potential issue. Similarly, for all sensors combined, as shown in the right-hand chart, the aggregated baseline mean (T1 to T3) is also approximately 122° F., while the aggregated current mean (T4) is 132° F., resulting in the same deviation of 10° F., which exceeds the example threshold and points to a system-wide trend. For real-time applications, overlapping or rolling windows may be used to continuously calculate and compare statistics as new data arrives. For example, a 10-minute sliding window could update every minute to provide a dynamic analysis of the rate of change. Additionally, time windows that are longer or shorter than the time periods T1, T2, T3 and T4 shown may be employed (whether or not overlapping). By employing time window analysis, significant deviations from baseline behavior can be identified promptly, enabling proactive anomaly detection and preventive maintenance for both individual components and system-wide issues. It is noted that the curves shown in FIG. 6 are for illustrative purposes only, and may otherwise not be drawn to scale or with high degrees of accuracy.

It will be appreciated after reading the present disclosure that different statistics may be used (singly or in any combination), and therefore the threshold for that different statistic may also be different. For example, in addition to, or as an alternative to the mean, various other statistics may be used to analyze the temperature rate of change, providing additional insights into the behavior and variability of the data. The median, which represents the middle value when the data is sorted, may be useful for identifying the central tendency when the data contains outliers, as it is less sensitive to extreme values than the mean. The variance, which is the square of the standard deviation, quantifies dispersion. The range, defined as the difference between the maximum and minimum values, highlights the extent of fluctuation in the rate of change over a given period. Additional insights can be gained from percentiles, such as the 25th, 50th (median), and 75th percentiles, which help understand the distribution of the data and identify extreme values, such as the 95th percentile for high deviations. Maximum and minimum values are particularly useful for identifying extreme behaviors or anomalies, such as sudden spikes or drops. Skewness, which measures the asymmetry of the rate-of-change distribution, can indicate whether the data is biased toward rapid increases (positive skew) or decreases (negative skew), while kurtosis, which measures the “tailedness” of the distribution, highlights the likelihood of extreme values.

In some implementations, moving averages, including the simple moving average and the exponentially weighted moving average (EWMA), smooth out short-term fluctuations to identify longer-term trends. The cumulative sum (CUSUM) tracks the cumulative deviations from a target or baseline value, making it effective for detecting gradual drifts in the rate of change. The z-score measures how many standard deviations a value is from the mean and is particularly useful for identifying anomalies. Additionally, tracking the frequency of positive or negative changes provides insights into whether the parameter is trending upward or downward over time.

More advanced metrics, such as autocorrelation, measure the correlation of the rate of change with itself at different time lags, revealing patterns or periodicity in the data. Peak-to-peak amplitude, which measures the difference between successive peaks and troughs, is useful for analyzing oscillatory behavior or sudden shifts. These statistics can be applied in various scenarios: median and percentiles for robust analysis of noisy data with outliers, standard deviation and variance for understanding stability and variability, and CUSUM and z-score for trend detection and identifying deviations from the norm. Collectively, these statistics complement the mean by offering additional layers of analysis, enabling a more nuanced understanding of the temperature rate of change and facilitating effective monitoring and decision-making. As such, the use of the mean should be taken as example only and not to otherwise limit the scope of the present disclosure.

In some implementations, monitoring process 110 may provide 408 an electronic notification that the current value of the statistic exceeds the threshold for the vehicle component relative to the historical value of the statistic. For instance, once monitoring process 110 determines that the current value of the statistic exceeds the threshold for the vehicle component relative to the historical value of the statistic of the rate of change data of the parameter for at least one prior period of time (indicating a potential problem with the component, monitoring process 110 may provide an electronic notification. For example, the notification may take several forms depending on the use case and setup. For in-vehicle alerts, monitoring process 110 may display (as discussed above) a warning on a dashboard, such as a visual indicator (e.g., a warning light) or a textual message stating, “High Rate of Change Detected in Wheel-End Bearing.” Haptic alerts may also be used (e.g., vibrating seat or steering wheel). Additionally, monitoring process 110 may transmit notifications remotely to fleet management systems or cloud-based platforms (e.g., via cellular or satellite communication), ensuring that fleet operators or technicians are informed in real-time. These notifications may include detailed information such as the component ID, the magnitude of the mean shift, and the exceeded threshold. For integration with predictive maintenance systems, the event may also be logged automatically, triggering an inspection or repair schedule.

In addition to issuing alerts, monitoring process 110 may log the event with a timestamp, component identification, and the calculated mean shift for tracking and analysis. This data may be visualized in real-time through dashboards or mobile applications, allowing operators to monitor vehicle health dynamically. For instance, a fleet manager or driver may receive a detailed alert that reads: “Component ID: Wheel-End Bearing 3. Mean Shift=10° F./second (Threshold=5° F./second). Immediate inspection recommended.”

In some implementations, providing the electronic notification that the current value of the statistic exceeds the threshold for the vehicle component relative to the historical value of the statistic may include providing 414 the electronic notification prior to the parameter exceeding a next threshold for the parameter unrelated to the rate of change of the parameter. For instance, a temperature threshold that is unrelated to the rate of change of the temperature may be an absolute temperature threshold (i.e., once the temperature from component sensor 215 reads a temperature past X degrees, regardless of how long it takes to pass X degrees). While the present disclosure may make use of an absolute temperature threshold notification, that type of threshold notification is understood to be an addition to the threshold for the temperature related to the rate of change, rather than a substitution for the threshold for the temperature related to the rate of change. This is at least due to an electronic notification based on the mean shift of the rate of change providing an early warning long before reaching an absolute temperature threshold, which is typically set at a much higher level and indicates imminent catastrophic failure.

As an example, monitoring process 110 may monitor the rate of change of the temperature rather than just the absolute temperature itself. By calculating and analyzing the mean shift of the rate of change over a defined time window, monitoring process 110 identifies trends that suggest the temperature is rising abnormally. For instance, if the baseline rate of change is approximately 0° F./second and the current rate is steadily increasing at 10° F./second, monitoring process 110 may recognize this deviation and send a notification when it exceeds a predefined threshold, such as 5° F./second. This allows for detection of abnormal behavior while the absolute temperature is still within a safe range.

Absolute temperature thresholds, on the other hand, are generally set to detect critical conditions (e.g., 250° F. or higher for wheel-end bearings) that signal imminent failure. By the time the temperature reaches such levels, the component may already be severely damaged or on the verge of failure. In contrast, monitoring process 110 may be based on mean shift analysis, and can detect abnormal trends early, such as a steady temperature rise due to a failing bearing or insufficient lubrication, even if the absolute temperature is still well below the critical threshold.

For example, consider a wheel end bearing with a baseline temperature of 120° F. and a maximum absolute threshold of 250° F. In the example, monitoring process 110 may detect that the temperature is rising at a rate of 10° F./second and send a notification as soon as the rate of change exceeds the 5° F./second threshold. At this point, the absolute temperature might still be around 140° F.-far below the catastrophic threshold of 250° F. but the early alert allows for proactive investigation and maintenance. This early warning system prevents the temperature from reaching dangerous levels, reducing the risk of component failure and ensuring vehicle safety. By addressing the issue at the trend stage rather than waiting for absolute temperature thresholds to be breached, monitoring process 110 provides a significant operational and safety advantage.

While the example component described throughout is a wheel end (including portions thereof such as wheel end bearing, wheel end oil, etc.), it will be appreciated after reading the present disclosure that other components may be used without departing from the scope of the present disclosure. For instance, other example components may include the engine system (e.g., engine coolant, engine oil, cylinder heads, turbocharger, etc.), transmission system (e.g., transmission fluid, clutch, etc.), braking system (e.g., brake rotors/discs, brake pads, wheel bearings, hubs, brake actuators, etc.), exhaust system (e.g., exhaust gas temperature, catalytic converter, diesel particular filter, etc.), tire pressure systems, electrical and battery systems (e.g., alternator, electric motor, battery, battery charger, etc.), fuel system (e.g., fuel pump, fuel injectors, etc.), HVAC systems (refrigerant compressor, cabin heater core, etc.), suspension and drivetrain (e.g., differentials, driveshafts/propshafts, etc.), as well as power steering systems and hydraulic systems. As such, the description of a wheel end as the component should be taken as example only and not to otherwise limit the scope of the present disclosure.

In some implementations, the parameter may be one of temperature, vibration signature, and noise level (e.g., dB level). For instance, while the example parameter described throughout is temperature, it will be appreciated after reading the present disclosure that other parameters may be used without departing from the scope of the present disclosure. For instance, other example parameters may include vibration signature, noise level, oil level (e.g., wheel end oil level), brake actuator stroke (travel), tire pressure, etc. For example, monitoring 400 vibration signatures and noise levels in vehicles can provide valuable insights into the health and performance of various components. Vibration analysis may be beneficial for detecting wear, misalignment, imbalance, or failure in rotating and moving parts. In the engine system, monitoring vibration can identify issues with engine mounts, crankshafts, or camshafts, such as worn mounts, imbalances, or bearing wear. In the drivetrain, vibrations in the driveshaft or propshaft can signal imbalance, bent shafts, or worn universal joints, while in the transmission, they can indicate gear misalignment, bearing issues, or excessive wear. Similarly, differentials benefit from vibration monitoring to detect gear wear or misalignment. The wheel and tire system also greatly benefits, as vibrations can reveal uneven tire tread wear, improper inflation, or imbalance, as well as wheel bearing or hub misalignment issues. In the suspension system, vibrations in shock absorbers, struts, control arms, or bushings can indicate wear or damage, while in the brake system, vibrations during braking often point to warped rotors or uneven wear. Additionally, electric motors in EVs or hybrids may exhibit vibrations due to misaligned or worn motor bearings.

Noise level (dB) monitoring, on the other hand, may help detect unusual sounds that can signal mechanical issues or wear. In the engine system, noises such as clicking or tapping may indicate valve or lifter issues, while whining or rattling can suggest timing chain or belt problems, and high-pitched whistling from the turbocharger often points to damage. In the drivetrain, grinding or whining in the transmission signals gear or bearing wear, and whining or clunking in the differential may indicate gear misalignment or wear. For the wheel and tire system, unusual noise levels often stem from tire tread issues or improper inflation, while humming or growling sounds from wheel bearings suggest wear or failure. The suspension system may produce clunking or knocking noises in shock absorbers or struts, and squeaking or popping sounds from control arms or ball joints, signaling wear. The brake system can produce squealing or grinding noises that indicate worn pads or rotors, or clunking sounds from loose or worn calipers. Noise monitoring also applies to the HVAC system, where excessive noise from the blower motor suggests a failing motor or obstructions, and clicking or rattling from the compressor points to wear or internal issues. In the exhaust system, loud roaring can indicate muffler or exhaust pipe leaks, while rattling sounds in the catalytic converter may signal internal damage.

Certain components may benefit from both vibration and noise monitoring. For example, wheel bearings may exhibit vibrations and humming or growling noises when worn, while transmission components can produce both vibrations and grinding or whining sounds when issues arise. Similarly, driveline components like shafts and joints can experience imbalance-related vibrations and noise from worn parts. Monitoring these aspects enables early fault detection, reducing the risk of catastrophic failures and unplanned downtime, and improving safety by identifying dangerous conditions like brake or tire failure. This proactive approach also optimizes efficiency, ensuring components operate smoothly and quietly.

The terminology used herein is for the purpose of describing particular implementations only and is not intended to be limiting of the disclosure. As used herein, the singular forms “a”, “an” and “the” are intended to include the plural forms as well, including any steps performed by a/the computer/processor, unless the context clearly indicates otherwise. As used herein, the phrase “at least one of A, B, and C” should be construed to mean a logical (A OR B OR C), using a non-exclusive logical OR, and should not be construed to mean “at least one of A, at least one of B, and at least one of C.” As another example, the language “at least one of A and B” (and the like) as well as “at least one of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof. Example sizes/models/values/ranges can have been given, although examples are not limited to the same.

The terms (and those similar to) “coupled,” “attached,” “connected,” “adjoining,” “transmitting,” “communicating,” “receiving,” “connected,” “engaged,” “adjacent,” “next to,” “on top of,” “above,” “below,” “abutting,” and “disposed,” used herein is to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action is to occur, either in a direct or indirect manner. The term “set” does not necessarily exclude the empty set—in other words, in some circumstances a “set” may have zero elements. The term “non-empty set” may be used to indicate exclusion of the empty set—that is, a non-empty set must have one or more elements, but this term need not be specifically used. The term “subset” does not necessarily require a proper subset. In other words, a “subset” of a first set may be coextensive with (equal to) the first set. Further, the term “subset” does not necessarily exclude the empty set-in some circumstances a “subset” may have zero elements.

The corresponding structures, materials, acts, and equivalents (e.g., of all means or step plus function elements) that may be in the claims below are intended to include any structure, material, or act for performing the function in combination with other claimed elements as specifically claimed. While the disclosure describes structures corresponding to claimed elements, those elements do not necessarily invoke a means plus function interpretation unless they explicitly use the signifier “means for.” Unless otherwise indicated, recitations of ranges of values are merely intended to serve as a shorthand way of referring individually to each separate value falling within the range, and each separate value is hereby incorporated into the specification as if it were individually recited. While the drawings divide elements of the disclosure into different functional blocks or action blocks, these divisions are for illustration only. According to the principles of the present disclosure, functionality can be combined in other ways such that some or all functionality from multiple separately-depicted blocks can be implemented in a single functional block; similarly, functionality depicted in a single block may be separated into multiple blocks. Unless explicitly stated as mutually exclusive, features depicted in different drawings can be combined consistent with the principles of the present disclosure. Moreover, although this disclosure describes and depicts respective implementations herein as including particular components, elements, feature, functions, operations, or steps (and arrangements thereof), any of these implementations may include any combination, arrangement, or permutation of any of the components, elements, features, functions, operations, or steps described or depicted anywhere herein that a person having ordinary skill in the art would comprehend after reading the present disclosure. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The description of the present disclosure has been presented for purposes of illustration and description but is not intended to be exhaustive or limited to the disclosure in the form disclosed. After reading the present disclosure, many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated. The features of any dependent claim may be combined with the features of any of the independent claims or other dependent claims.

The implementations disclosed herein are only examples, and the scope of this disclosure is not limited to them. Implementations may include all, some, or none of the components, elements, features, functions, operations, or steps of the embodiments disclosed herein. The dependencies or references back in the attached claims are chosen for formal reasons only; however, any subject matter resulting from a deliberate reference back to any previous claims can be claimed as well, so that any combination of claims and the features thereof are disclosed and can be claimed regardless of the dependencies chosen in the attached claims. The subject-matter that can be claimed comprises not only the combinations of features as set out in the attached claims, but also any other combination of features in the claims, where each feature mentioned in the claims can be combined with any other feature or combination of other features in the claims. Furthermore, any of the implementations and features described or depicted herein can be claimed in a separate claim and/or in any combination with any implementation or feature described or depicted herein or with any of the features of the attached claims.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
monitoring, by a computing device, data from at least one data source, wherein the data from the at least one data source is representative of a parameter associated with a vehicle component of a plurality of vehicle components;
determining, based on the data, rate of change data of the parameter with respect to time;
determining a current value of a statistic of the rate of change data of the parameter over a current period of time;
determining that the current value of the statistic exceeds a threshold for the vehicle component relative to a historical value of the statistic of the rate of change data of the parameter for at least one prior period of time; and
providing an electronic notification that the current value of the statistic exceeds the threshold for the vehicle component relative to the historical value of the statistic.

2. The computer-implemented method of claim 1, wherein determining that the current value of the statistic exceeds the threshold for the vehicle component relative to the historical value of the statistic includes using time window analysis.

3. The computer-implemented method of claim 1, wherein the threshold for the vehicle component is a threshold amount of deviation in a mean value of the parameter.

4. The computer-implemented method of claim 1, wherein determining the rate of change data of the parameter with respect to time includes summing the rate of change data from the at least one data source over the current period of time.

5. The computer-implemented method of claim 1, wherein providing the electronic notification that the current value of the statistic exceeds the threshold for the vehicle component relative to the historical value of the statistic includes providing the electronic notification prior to the parameter exceeding a next threshold for the parameter unrelated to the rate of change of the parameter.

6. The computer-implemented method of claim 1, wherein the parameter is one of temperature, vibration signature, and noise level.

7. The computer-implemented method of claim 1, wherein the vehicle component is a wheel end.

8. A computer program product residing on a computer readable storage medium having a plurality of instructions stored thereon which, when executed across one or more processors, causes at least a portion of the one or more processors to perform operations comprising:
monitoring data from at least one data source, wherein the data from the at least one data source is representative of a parameter associated with a vehicle component of a plurality of vehicle components;
determining, based on the data, rate of change data of the parameter with respect to time;
determining a current value of a statistic of the rate of change data of the parameter over a current period of time;
determining that the current value of the statistic exceeds a threshold for the vehicle component relative to a historical value of the statistic of the rate of change data of the parameter for at least one prior period of time; and
providing an electronic notification that the current value of the statistic exceeds the threshold for the vehicle component relative to the historical value of the statistic.

9. The computer program product of claim 8, wherein determining that the current value of the statistic exceeds the threshold for the vehicle component relative to the historical value of the statistic includes using time window analysis.

10. The computer program product of claim 8, wherein the threshold for the vehicle component is a threshold amount of deviation in a mean value of the parameter.

11. The computer program product of claim 8, wherein determining the rate of change data of the parameter with respect to time includes summing the rate of change data from the at least one data source over the current period of time.

12. The computer program product of claim 8, wherein providing the electronic notification that the current value of the statistic exceeds the threshold for the vehicle component relative to the historical value of the statistic includes providing the electronic notification prior to the parameter exceeding a next threshold for the parameter unrelated to the rate of change of the parameter.

13. The computer program product of claim 8, wherein the parameter is one of temperature, vibration signature, and noise level.

14. The computer program product of claim 8, wherein the vehicle component is a wheel end.

15. A computing system including one or more processors and one or more memories configured to perform operations comprising:
monitoring data from at least one data source, wherein the data from the at least one data source is representative of a parameter associated with a vehicle component of a plurality of vehicle components;
determining, based on the data, rate of change data of the parameter with respect to time;
determining a current value of a statistic of the rate of change data of the parameter over a current period of time;
determining that the current value of the statistic exceeds a threshold for the vehicle component relative to a historical value of the statistic of the rate of change data of the parameter for at least one prior period of time; and
providing an electronic notification that the current value of the statistic exceeds the threshold for the vehicle component relative to the historical value of the statistic.

16. The computing system of claim 15, wherein determining that the current value of the statistic exceeds the threshold for the vehicle component relative to the historical value of the statistic includes using time window analysis.

17. The computing system of claim 15, wherein the threshold for the vehicle component is a threshold amount of deviation in a mean value of the parameter.

18. The computing system of claim 15, wherein determining the rate of change data of the parameter with respect to time includes summing the rate of change data from the at least one data source over the current period of time.

19. The computing system of claim 15, wherein providing the electronic notification that the current value of the statistic exceeds the threshold for the vehicle component relative to the historical value of the statistic includes providing the electronic notification prior to the parameter exceeding a next threshold for the parameter unrelated to the rate of change of the parameter.

20. The computing system of claim 15, wherein the parameter is one of temperature, vibration signature, and noise level.

21. The computing system of claim 15, wherein the vehicle component is a wheel end.
